(19) United States
(12) Patent Application Publication
(10) Pub. No.: US 2009/0051558 A1
(43) Pub. Date: Feb. 26, 2009

(54) Method and apparatus for providing optical indications about a state of a circuit

(75) Inventor: Jay H. Dorval, Lucas, TX (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Bedford, Inc.

(21) Appl. No.: 11/894,099

(22) Filed: Aug. 20, 2007

(51) Int. Cl. G08B 21/00; G08B 5/00

(52) U.S. Cl. 340/653; 340/815.45

(57) ABSTRACT

An apparatus or corresponding method according to an embodiment of the invention provides optical indications about the state of a circuit on a circuit board. A standard Small Form-Factor Pluggable (SFP) connector component and an optical light transmission element are arranged at different angles relative to an edge of the circuit board, with the connector component being angled other than perpendicular to an edge of the circuit board to increase the density of connector components per circuit board or relieve bending strain on an external cable connected to the connector component. The optical light transmission element may include at least three mounting features to attach the transmission element to the circuit board. The optical light transmission element includes a light propagating region, supporting total internal reflection, and a light-emitting end to output light at a front panel of the circuit board near the associated connector component. A single piece embodiment eliminates a separate clip, thereby increasing ease of manufacture, assembly, and repair while decreasing cost.

### BACKGROUND OF THE INVENTION

Transceiver connector modules typically provide for bi-directional data transmission between two or more devices, such as modems, network interfaces and computer systems. Small Form-Factor Pluggable (SFP) transceiver modules are one industry standard used for this purpose. SFP supports both fiber optic and cable assemblies. The SFP transceiver module is inserted into a complimentary metal cage assembly mounted to a printed circuit board. In order to verify that a connection has been established between the transceiver modules, indicators, such as light emitting diodes (LEDs), are incorporated into the printed circuit board behind the SFP cage to indicate whether or not data is being received. Because the circuit connection is established behind a front panel of a circuit board that supports these devices, the status of the circuit, and the light generated by an associated LED, must be relayed outside of the device to an operator's side of the front panel for an operator to know the status of a circuit.

An ability to provide visual monitoring of the status of internal circuits is useful to knowing the functional state of transceiver modules or other circuits on a circuit board. One approach to this problem is to incorporate an optical waveguide or “light pipe” adjacent to the LED mounted on the printed circuit board such that it extends to the front panel. The optical waveguide transmits the LED-emitted light to a display area on the front panel. However, advances in the telecommunications industry and the quest for greater functionality have diminished the circuit board space available for devices providing state information of a circuit to an observer at a rack supporting the circuit board.

### SUMMARY OF THE INVENTION

One example embodiment of the invention is an apparatus or corresponding method to indicate the state of a circuit. The example embodiment of the invention may include a connector component connected to a circuit board to accept a mating connector component at a location that may be a non-perpendicular first angle relative to an edge of the circuit board. The example embodiment may also include an optical light transmission element and at least three mounting features to connect the transmission element to the circuit board. The optical light transmission element may include a light-receiving end configured to accept a light projected by an optical light-generating device configured to illuminate as a function of a state of the circuit. The optical light transmission element may further include a light propagation region configured to support propagation of the light for a given length. The optical light transmission element may also include a light-emitting end to output the light at the mating location of the connector component at a second angle relative to the edge of the circuit board, other than at the first angle, to associate light output by the light-emitting end with the state of the circuit on the circuit board.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram of an electronics rack (e.g., network system) with circuit boards equipped with network interfaces employing an example embodiment of the invention;

FIG. 2 is a mechanical diagram of a circuit board assembly with a circuit board inside the electronics rack and multiple light transmission elements arranged in an array above Small Form-Factor Pluggable (SFP) cages;

FIG. 3A is a close-up of a mechanical diagram of a circuit board with multiple light transmission elements according to an example embodiment of the invention;

FIG. 3B is a bottom view of the circuit board of FIG. 3A illustrating mounting features of the multiple light transmission elements;

FIGS. 4A-1, 4A-2, and 4A-3 are mechanical diagrams at multiple angles of an example embodiment of the invention illustrating the mounting features, light-receiving end, light propagation region, light-emitting end, and a support between adjacent light propagation regions;

FIG. 4B is a close-up view of an example embodiment of the invention illustrating a textured surface of a light-emitting end of a light transmission element;

FIG. 5 is an optical ray trace diagram of an embodiment of the invention redirecting light from a light-emitting diode (LED) toward an observer;

FIG. 6 is a flow diagram of an example method of the invention;

FIG. 7 is a flow diagram of a method of manufacturing a circuit board employing an example embodiment of the invention.

### DETAILED DESCRIPTION OF THE INVENTION

A description of example embodiments of the invention follows.

Telecommunications industry advances have reduced circuit board space availability for devices providing state information of a circuit to an observer at a rack supporting a circuit board with the circuit. There is also a trend in the telecommunication industry, and other industries, towards development of high density transceiver components, which, in some applications, causes small form-factor pluggable (SFP) cage modules to be angled to increase their density. In such cases, the spatial allotment and placement positions available for state information indicators, including light guides that project light representing a state of a circuit, are even more restricted.

Because of this, many light guides are either mounted in an unstable manner, making them prone to tilting, especially where multiple light guides are to be positioned relative to each other during assembly and aligned at a perpendicular angle for assembly with a front panel. The cost of manufacturing electronic equipment containing conventional light guides is increased by this problem, as is the difficulty in dismantling front display panels and circuit boards for servicing.

A conventional light guide typically provides stability by fastening the light guide to a connector module with a clip. Other conventional methods utilize notched hooks on a light-emitting end of the light guide for hooking the light guide to an inside of the front panel. However, neither of these solutions provides satisfactorily secure mounting, and neither allows the connector module to be angled through the front panel at an angle other than a 90 degree angle (i.e., perpendicular). A 90 degree angle decreases a density of connector modules that can be mounted on a given circuit board, increases manufacturing and repair costs of the devices, and decreases overall functionality.

An example embodiment of the present invention is an apparatus and corresponding method for providing optical indications about a state of a circuit on a circuit board. A connector component is positioned at a non-perpendicular first angle relative to an edge of the circuit board and configured to accept a mating component. The example apparatus includes an optical light transmission element with at least three mounting features. The mounting features allow the transmission element to be secured to the circuit board at a straight or angled position relative to the connector component. The transmission element further includes a light-receiving end that accepts light projected by an optical light-generating device, such as a light-emitting diode (LED). The light-generating device itself is configured to illuminate as a function of a state of a circuit. The light transmission element also includes a light propagation region configured to support propagation of the light for a given length. The transmission element also has a light-emitting end to output the light at a location near where the connector component accepts the mating component. The light is outputted at a second angle relative to the edge of the circuit board, the second angle being different from the first angle of the connector component relative to the edge of the circuit board. The light-emitting end thereby associates the light output by the transmission element with the state of the circuit on the circuit board associated with the connector component.

The mounting features may be configured to be press-fitted into the circuit board, which allows the light-receiving end to be positioned above a surface-mounted LED, for example. The LED may be a multi-colored LED.

The light propagation region may include at least one geometric structure supporting propagation of the light. Further, there may be multiple geometric structures configured to be parallel to each other with at least one support connecting the parallel geometric structures to provide structural stiffness of the geometric structure. The geometric structure(s) may cause the light to be redirected along a path substantially offset from, and along, a longitudinal axis of a surface plane of the circuit board. The light propagation region may be constructed of clear plastic.

The connector component may include a standard Small Form-Factor Pluggable (SFP) cage. The SFP cage may be mounted to the circuit board. In order to increase the density connector components on the circuit board, the SFP cage may be arranged in angled rows with transceiver module cages plugged into the receptacle SFP cages.

The light-emitting end may include a textured surface through which the light is outputted to ensure visibility from a broad range of viewing angles. The light-emitting end may be configured to output light through a front panel housing the circuit board. The outputted light may provide optical indications of the state of the circuit connected to the SFP cage as a function of light generated by the LED.

The light transmission element may be attached to the circuit board without modification. An example embodiment of the invention includes a single-piece structure that eliminates need for a separate clip, increases stability, reduces costs, and permits increased transceiver module connector density compared to conventional light guides.

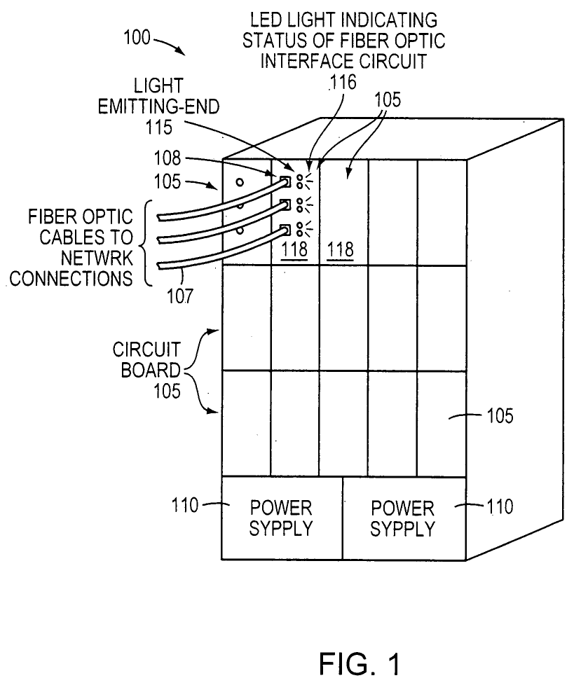

FIG. 1 is a diagram of an apparatus including an electronics rack 100, such as a network system with multiple shelves of circuit boards 105, utilizing an example embodiment of the present invention. For purposes of describing the electronics rack 100 in a context of a network, the electronics rack 100 may interchangeably be referred to herein as a network system 100 or network interface. The network system 100 includes the circuit boards 105, fiber optic cables 107 connected to circuit board connectors 108 to establish network connections, and power supplies 110. The network system 100 further includes light-emitting ends 115 of optical light transmission elements (not shown) adjacent to front panels 118 of the circuit boards 105. The light-emitting ends 115 output LED-emitted light 116, thereby indicating the state of a fiber optic interface circuit (not shown) established inside the network system 100. In this example embodiment, the light-emitting ends 115 are more stably aligned or angled with the front panel as compared to conventional methods understood in the art. Furthermore, in the example embodiment, the fiber optic cables 107 can be integrated into the circuit boards 105 at a greater density compared to the conventional methods understood in the art because of the angle of the circuit board connectors.

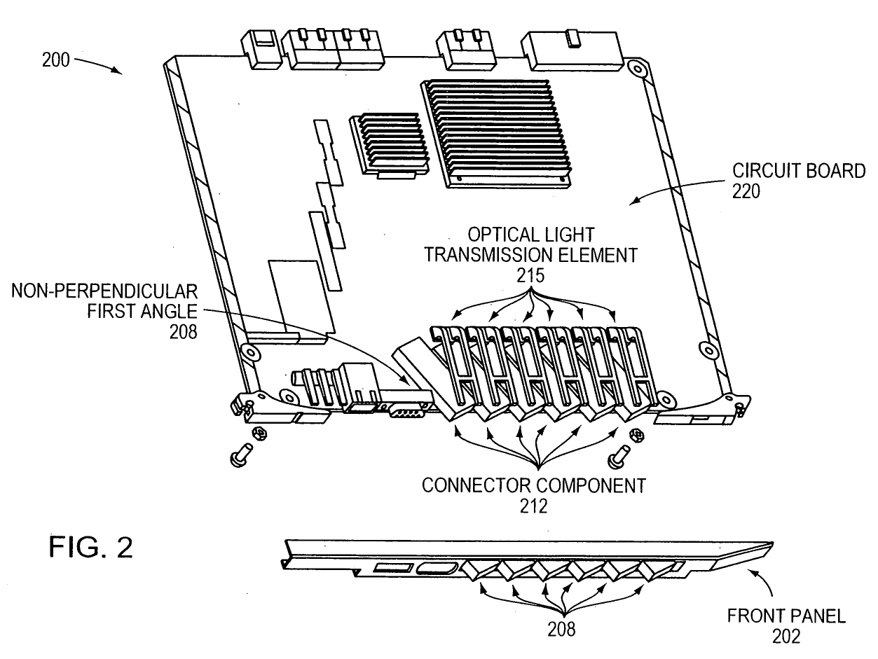

FIG. 2 is a mechanical diagram of a circuit board assembly 200 within the network system 100 of FIG. 1. In the example embodiment of FIG. 2, the circuit board assembly 200 may include a circuit board 220. Connector components 212 protrude through a front panel 202 of the network system. The connector components 212 accept mating components of fiber optic cables, for example a state of a circuit responsive to the connection is relayed to respective LEDs positioned behind the connector components 212. The connector components 212 in this example embodiment can be positioned at a non-perpendicular first angle 208 such that available surface area is maximized for the placement of additional connector components and, secondarily, for strain relief purposes to reduce bending on the cables plugged into the connector components 212. The optical light transmission elements 215 may be positioned above the LEDs and behind the connector components. In this position, the light transmission elements may redirect light emitted by the LED to a location outside the circuit board assembly 200 near the connector components 208 positions on the front panel 202.

The optical light transmission elements 215 may include at least three mounting features to secure it soundly to a circuit board for ease of assembly with a front panel. Assembly through a front panel is facilitated by maintaining the ends of multiple light transmission elements 215 in alignment relative to each other. Enhanced stability allows multiple light guides to be packaged in closer proximity and presented at an angle. The example embodiment reduces the cost of assembling electronic equipment and further permits a reduction in size of the equipment. The optical light transmission elements 215 are mechanically independent from connector components 312.

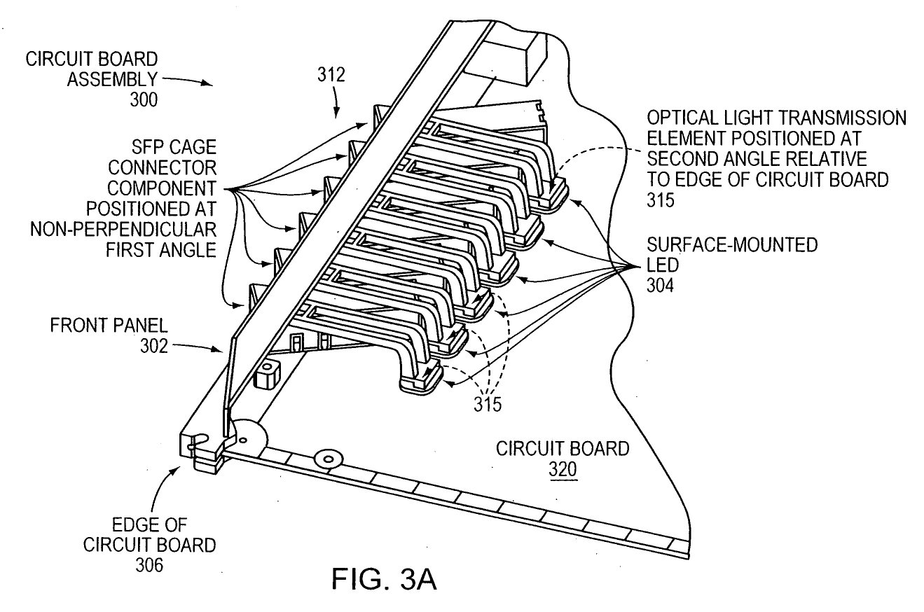

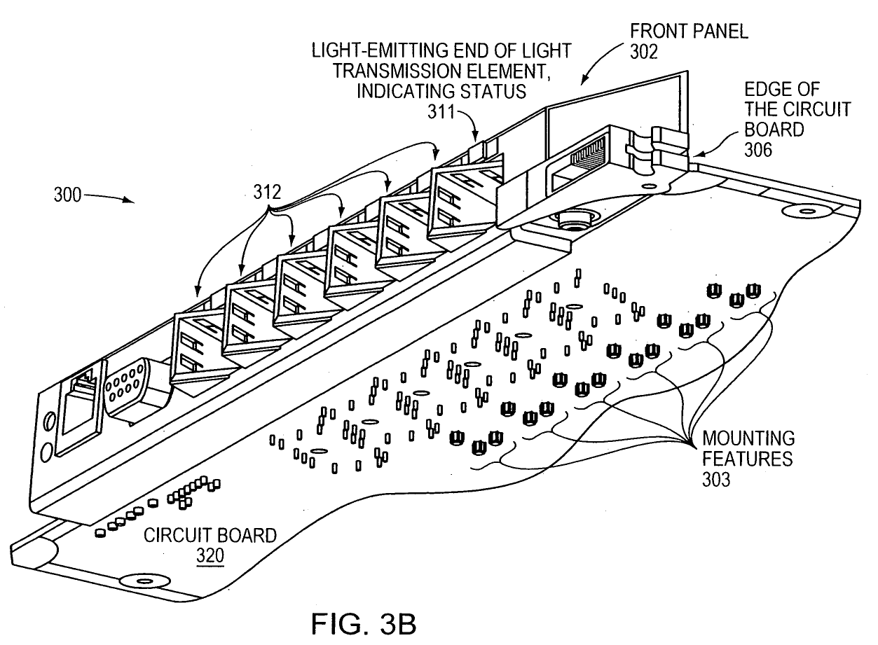

FIG. 3A is a close-up view of a mechanical diagram of a circuit board assembly 300 with SFP cage connector components 312 positioned at a non-perpendicular first angle relative to an edge 306 of the circuit board 320 and protruding through a front panel 302 of the circuit board assembly 300. In this example embodiment, optical light transmission elements 315 may be defined by positioning at a second angle relative to the edge 306 of the circuit board 320 and located above surface-mounted LEDs 304 to capture light emitted by the LEDs 304 to project the light through the front panel 302.

FIG. 3B is a bottom view of a mechanical diagram of the circuit board assembly 300. In an example embodiment of the invention, mounting features 303 of the light transmission elements 315 may be securely press-fitted into the circuit board 320, as illustrated. In this example embodiment, the mounting features 303 can be secured into openings in the circuit board 320 and positioned behind SFP cage connector components 312 without the use of special tools or fixturing. Light-emitting ends 311 of the light transmission elements 315 extend to the front panel 302 of the circuit board assembly 300 and emit light indicating status of a circuit (not shown) to which the LEDs 304 are connected.

FIGS. 4A-1, 4A-2 and 4A-3 are a series of mechanical diagrams providing different viewing angles of a light transmission element 400 according to an example embodiment of the invention. The light transmission element 400 includes (i.e., defines) three mounting features 403 to secure a light-receiving end 413 having light-receiving surface(s) 414 to receive light into the light transmission element 400. The light-receiving end 413 may include a curved portion 412 to redirect light along a path other than its original direction. In this example embodiment, light travels along dual, parallel light propagation regions 418. It should be noted that the curved portion 412 may also be defined herein to be within the light propagation regions 418.

The parallel light propagation regions 418 may be a geometric structure and may be rectangular in shape or have another shape that can support propagation of light. Further, there may be a support 422 between the adjacent parallel geometric structures 419. This example embodiment also includes a light-emitting end 425 with a textured surface 430.

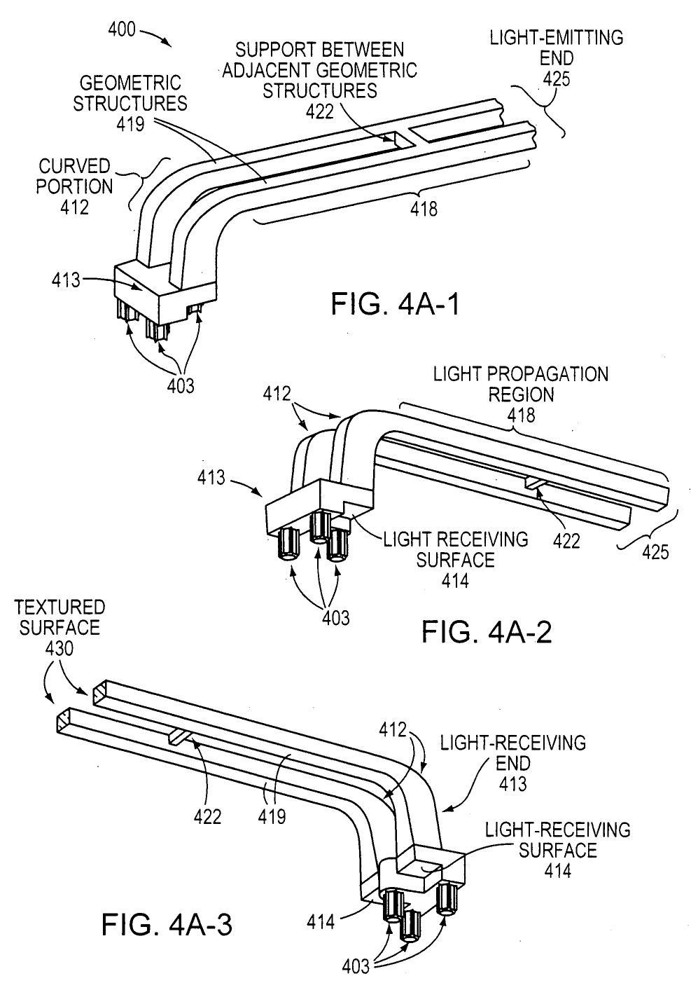

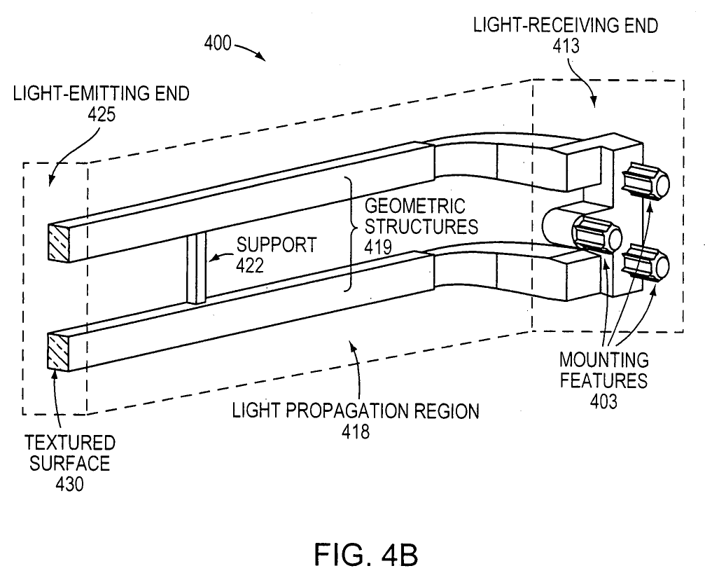

FIG. 4B is a close-up view illustrating the example embodiment of FIGS. 4A-1, 4A-2 and 4A-3, including the light-emitting end 425 that may be defined by textured surface 430. The surfaces 430 may be textured to better diffuse the light. The texturing may be accomplished either when the geometric shapes are cast or after the shape has been formed.

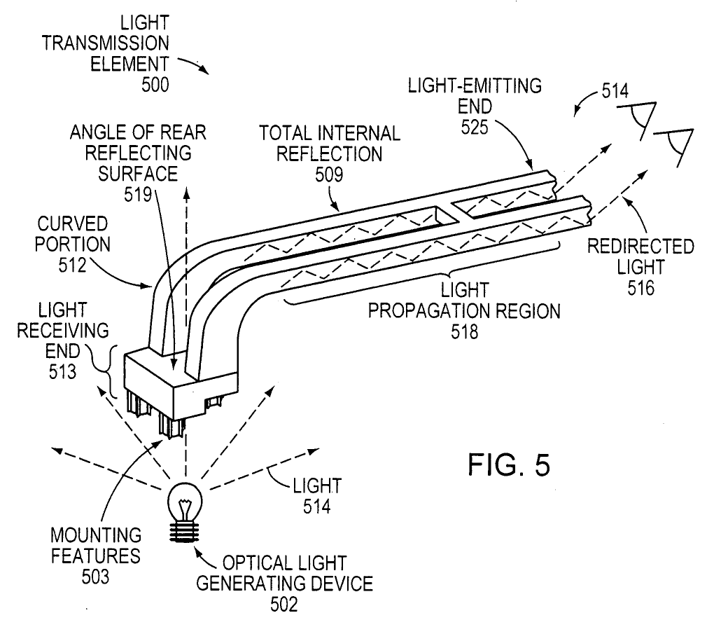

FIG. 5 is an optical ray trace diagram illustrating the movement (i.e., path) of light through a light transmission element 500 according to an example embodiment of the invention. Light 514 is generated by an optical light-generating device 502, generically illustrated as a light bulb, but it should be understood that the device 502 may be any form of light-generating device, including a surface-mounted LED, for example. In this embodiment, mounting features 503 securely fasten a light-receiving end 513 in a position to receive the light 514 from the light-generating device 502. After receiving the light 514 from the light-generating device 502, the light-receiving end 513 may redirect a portion of the light along a curved portion 512. In this example embodiment of the invention, the curvature and the angle of the rear reflecting surface 519 are configured such that the light strikes the surface at an angle larger than the critical angle, which results in total internal reflection 509 of the light 514 that entered the light transmission 500 via the light-receiving end 513. The light internally reflects within the light propagation region 518 and exits via the light-emitting end 525, unless caused to exit prior to reaching the end 525, as redirected light 516. The redirected light 516 may then be observed so that the state of an associated circuit (not shown) may be determined visually by an observer.

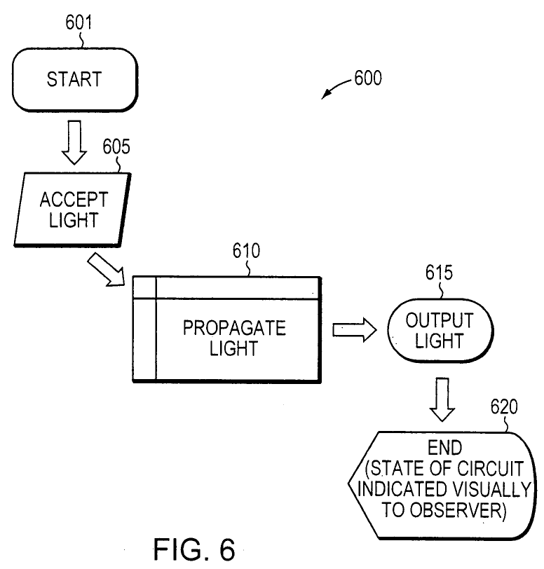

FIG. 6 is a flow diagram illustrating an example method (601) that begins with accepting light (605) projected by an optical light-generating device. Propagation (610) of the light may be supported for a given length in a direction other than the incident direction. The propagated light may then be outputted (615) such that, at the end (620) of the flow diagram 600, a state of a circuit corresponding to the light-generating device is indicated visually to an observer.

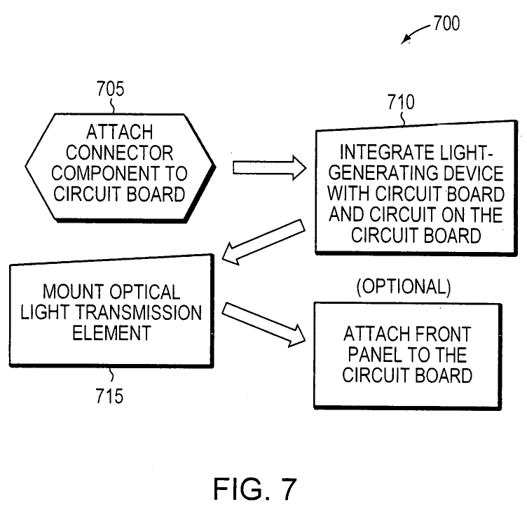

FIG. 7 is a flow diagram 700 illustrating a method of manufacturing a circuit board according to an embodiment of the invention. The flow diagram 700 begins by attaching (705) the connector component to a circuit board at a first angle (other than perpendicular) relative to an edge of the circuit board. The connector component may be an SFP cage, for example. Next, a light-generating device is integrated (710) with the circuit board and a circuit on the circuit board to produce light as a function of a state of the circuit board. An optical light transmission element may then be mounted (715) in optical arrangement with the light generating device, at a second angle relative to the edge of the circuit board, so that light can be accepted by the optical light transmission element. In an example embodiment of the invention, a front panel may be attached to the circuit board with the connector component and optical light transmission element projecting there through at their respective first and second angles.

While this invention has been particularly shown and described with references to example embodiments thereof, it will be understood by those skilled in the art that various changes in form and details may be made therein without departing from the scope of the invention encompassed by the appended claims.

For example, any material or combination of materials of sufficient optical clarity that can support total internal reflection and the propagation of light may be used to compose optical light transmission elements by way of example herein. Although the geometric structure of the light propagating regions are generally illustrated as being square or rectangular, it should be understood that almost any shape may employed. In addition, the mounting features may be press-fit pins or other functionally equivalent components. For example, although the mounting may be press-fitted into holes in the circuit board, an adhesive material may also be used. Similarly, although three mounting features are illustrated in the embodiments above, additional mounting features may be utilized. The mounting features may be ribbed and cylindrical, but additional smooth shapes may also be utilized. Further, the inclination of the internal reflection surface and the shape of the curved portion may vary. The length of propagation may be shortened or lengthened. Injection molding may be used to produce the various embodiments above, but other manufacturing processes may be utilized.

What is claimed is:

1. An apparatus for providing optical indications about a state of a circuit on a circuit board, comprising:
a connector component coupled to a circuit board to accept a mating connector component at a mating location at a non-perpendicular first angle relative to an edge of the circuit board; and
an optical light transmission element, with at least three mounting features to couple the transmission element to the circuit board, the optical light transmission element, including:
a light-receiving end configured to accept a light projected by an optical light-generating device configured to illuminate as a function of a state of the circuit;
a light propagation region configured to support propagation of the light for a given length; and
a light-emitting end to output the light at the mating location of the connector component at a second angle relative to the edge of the circuit board, other than at the first angle, to associate light output by the light-emitting end with the state of the circuit on the circuit board.

2. The apparatus of claim 1, wherein the mounting features are configured to be press-fitted into the circuit board to position the light-receiving end above a surface-mounted optical light emitting diode (LED).

3. The apparatus of claim 2, wherein the LED is a multi-color LED.

4. The apparatus of claim 1, wherein the propagation region is defined by at least one geometric structure supporting propagation of the light.

5. The apparatus of claim 4, wherein the at least one geometric structure includes multiple geometric structures configured to be parallel to each other and further including at least one support between adjacent geometric structures.

6. The apparatus of claim 4, wherein the at least one geometric structure causes the light to be redirected substantially offset from and along a longitudinal axis of a surface plane of the circuit board.

7. The apparatus of claim 4, wherein the at least one geometric structure is constructed of clear plastic.

8. The apparatus of claim 1, wherein the connector component includes a standard Small Form-Factor Pluggable (SFP) cage.

9. The apparatus of claim 1, wherein the light-emitting end includes a textured surface through which the light is outputted.

10. The apparatus of claim 1, wherein the light-emitting end is configured to output light through a front panel coupled to the circuit board.

11. A method for providing optical indications about a state of a circuit on a circuit board, the method comprising:
accepting light projected by an optical light-generating device configured to illuminate as a function of a state of a circuit on a circuit board, including a connector component coupled to a circuit board to accept a mating connector component at a mating location at a non-perpendicular first angle relative to an edge of the circuit board;
supporting propagation of the light for a given length; and
outputting the light at a second angle relative to the edge of the circuit board, other than the first angle, to associate light output by a light-emitting end with the state of the circuit on the circuit board.

12. The method of claim 11, wherein accepting the light includes accepting the light above a surface-mounted optical light emitting diode (LED).

13. The method of claim 12, wherein accepting the light includes accepting multiple colors of light.

14. The method of claim 11, wherein in supporting propagation of the light includes containing the light within at least one geometric structure for at least a portion of the given length.

15. The method of claim 14, wherein supporting propagation of the light includes multiple geometric structures configured to be parallel to each other and further including at least one support between adjacent geometric structures.

16. The method of claim 14, wherein supporting propagation of the light includes redirecting the light to travel substantially offset from and along a longitudinal axis of a surface plane of the circuit board.

17. The method of claim 14, wherein supporting propagation of the light includes at least one geometric structure constructed of clear plastic.

18. The method of claim 11, wherein accepting the light includes a standard Small Form-Factor Pluggable (SFP) cage.

19. The method of claim 11, wherein emitting the light includes outputting the light through a textured surface.

20. The method of claim 11, wherein emitting the light includes configuring the light-emitting end to output the light through a front panel coupled to a circuit board.

21. A method of manufacturing a circuit board assembly, comprising:
coupling a connector component to a circuit board to accept a mating connector component at a mating location at a non-perpendicular first angle relative to an edge of the circuit board;
coupling a light generating device to the circuit board and a circuit on the circuit board to illuminate the light generating device as a function of a state of the circuit; and
mounting an optical light transmission element with at least three mounting features to the circuit board to accept light generated by the light generating device, support propagation of the light for a given length, and output the light at the mating location of the connector component at a second angle relative to the edge of the circuit board, other than at the first angle, to associate light output by the light-emitting end with a state of the circuit on the circuit board.

22. The method of claim 21, wherein mounting the optical light transmission element to the circuit board includes press-fitting the at least three mounting features into the circuit board.

23. An apparatus for providing optical indications about a state of a circuit on a circuit board, comprising:
an optical light transmission element with at least three mounting features to couple to a circuit board with a circuit, the optical light transmission element including:
a light-receiving end configured to accept a light projected by an optical light-generating device configured to illuminate as a function of a state of the circuit;
a light propagation region configured to support propagation of the light for a given length; and
a light-emitting end to output the light in a manner associating light output by the light-emitting end with the state of the circuit on the circuit board.

24. The apparatus of claim 23, wherein the mounting features are configured to be press-fitted into the circuit board to position the light-receiving end above a surface-mounted optical light emitting diode (LED).

25. The apparatus of claim 23, wherein, in a state of coupling with the circuit board, the light-emitting end is isolated and vertically offset at an edge of a circuit board from a connector component at the edge of the circuit board and angularly offset from the connector component.

26. The apparatus of claim 23, wherein the propagation region is defined by at least one geometric structure supporting propagation of the light.

27. The apparatus of claim 26, wherein the at least one geometric structure includes multiple geometric structures configured to be parallel to each other and further including at least one support between adjacent geometric structures.

28. The apparatus of claim 26, wherein the at least one geometric structure causes the light to be redirected substantially offset from and along a longitudinal axis of a surface plane of the circuit board.

29. The apparatus of claim 26, wherein the at least one geometric structure is constructed of clear plastic.

30. The apparatus of claim 23, wherein the light-emitting end includes a textured surface through which the light is outputted.

31. The apparatus of claim 23, wherein the light-emitting end is configured to be coupled to a front panel of the circuit board to output light through the front panel.
